(19) United States
(12) Patent Application Publication
(10) Pub. No.: US 2012/0272841 A1
(43) Pub. Date: Nov. 1, 2012

(54) PELLET PRESS FOR PRODUCING PELLETS

(75) Inventors: Frank Heymanns, Oberderdingen (DE); Gernot von Haas, Heidelberg (DE); Günter Natus, Muhltal (DE); Detlef Kroll, Eppingen (DE)

(73) Assignee: Dieffenbacher GmbH Maschinen-und Anlagenbau

(21) Appl. No.: 13/504,713

(22) PCT Filed: Oct. 30, 2010
(86) PCT No.: PCT/EP10/06645

§ 371 Date: Jul. 23, 2012

(30) Foreign Application Priority Data
Oct. 30, 2009 (DE) 10 2009 051 360.4
May 6, 2010 (DE) 10 2010 028 711.3

(51) Int. Cl. B30B 9/00

(52) U.S. Cl. 100/94

(57) ABSTRACT

Pellet press producing pellets from material which is to be compressed. At least one rolling roller compresses the biomass in the press direction through holes of a die, which can be displaced by means of at least one drive, and/or rollers to form pellets. Sufficiently support a flat, annular and optionally segmented die, to prevent deformation and provide a pellet press in which a die that is moved and that comprises a support device has a minimum number of parts and/or mass passing through at least two press devices comprising a press frame with at least one roller. Pellet press in which at least one roller which is moved passes through at least two press frames. Die and/or rollers are displaceably mounted in at least two press frames and die is operatively connected to two coaxial support rings for forming an annular chamber and/or a support plate with perforations guiding the pellets in the press direction.

The invention relates to a pelletizing press for producing pellets according to the preamble of claim 1.

The production of pellets, also referred to as granules, from fine material or compacted and/or molten material is already known. The production of pellets, or wood pellets, from preferably chopped biomass, such as wood chips, sawdust, or the like, is also already sufficiently known and is propagated in the field of renewable energy sources as a pioneering technology for climate protection, in particular in Europe. Typically, chip material from the wood-processing industry is used as the raw material, however, freshly cut timber or types of wood which are not usable in the wood-processing industry or waste materials can also be used. Pollutant-free base material is preferably to be used for the market for wood pellets for supplying small furnace facilities in single-family or multifamily houses. Block power plants or special high-temperature furnace facilities for generating heat and/or obtaining electrical energy (combination power plants) can also cleanly combust pollutant-charged material (pellets made of particle board or medium-density fiberboard with or without a coating or lacquering) in small amounts, however.

The wood pellets are typically produced in so-called pelletizing presses, in which the material to be compressed is pressed through boreholes of a matrix by moving and/or actively rolling rollers, also referred to as pan grinder rollers. The material (biomass) is shaped by the boreholes and discharged as strands from the boreholes. Boreholes are understood as all openings which are preferably implemented as essentially cylindrical, and are arranged in a matrix to feed through and shape the material. The boreholes can also have larger intake areas (depressions) to improve the compression procedure and can be hardened or can have hardened sleeves in the boreholes. A differentiation is made between flat and ring matrices in the field of matrices. Rollers revolve externally or internally around on ring matrices for the compression, on flat matrices, the pan grinder rollers roll circularly (mill construction) or linearly reversing. The invention is preferably concerned with flat matrices of the latter construction, but can optionally also be used with ring matrices.

The possibilities for preparing and scattering the biomass, or the post-processing (chopping of the strands, cooling, storage, transport) of the pellets do not have to be discussed in greater detail. Reference is made in this regard to the prior art.

Due to the warming of the climate, which has been acknowledged worldwide in the meantime, the industry has been forced to accelerate and cheapen the large-scale industrial production of wood pellets. However, in particular in large production facilities, which are partially to be assigned to special mechanical engineering or heavy mechanical engineering, large and heavy machine parts are used.

Typical and known pelletizing presses having one or more pan grinder rollers revolving on a circular flat matrix typically have a drive, which drives the flat matrix or the pan grinder rollers via a hollow shaft passing through the flat matrix. The revolving pan grinder rollers are typically mounted overhung on the hollow shaft or the drive via quick-release axles protruding from the hollow shaft. The roller bearings between the quick-release axles and the pan grinder rollers wear very rapidly due to the centrifugal forces and the one-sided loads in the overhung mounting. The restriction of the fundamental system is also concealed in the central drive solution, proceeding from the central middle axis of the flat matrix, because for reasons of the occurring torques or the maximum advisable size of the hollow shaft, the circumference of such a pelletizing press is limited. It is also disadvantageous that in the case of a hollow shaft or a central drive shaft, the installation space inside the internal diameter of a perforated matrix is obstructed, and in addition to the required supports of the matrix, an extensive hollow shaft having appropriate stiffness and accompanying mass must also be moved. It is clearly obvious that this embodiment of the pelletizing press having a central hollow shaft or drive axle for a matrix reaches limits from approximately 1 m of internal diameter of the ring matrix.

The object of the invention comprises providing a pelletizing press for producing pellets, which can adequately support a flat, ring-shaped, and optionally segmented matrix against sagging independently of the strength properties. Simultaneously, a pelletizing press is to be provided, in which a matrix to be moved having support device has a minimum amount of parts or mass and passes through at least two pressing devices consisting of a press frame having at least one roller.

Alternatively, a pelletizing press is to be provided, in which at least one roller to be moved passes through at least two press frames.

The achievement of the object for a pelletizing press is that the matrix and/or the rollers are arranged as mounted so they are movable in at least two press frames, and the matrix is operationally linked to two coaxially arranged support rings to implement a ring chamber and/or a support plate having openings for feeding through the pellets in the pressing direction.

In an expansion of the object, advantages are to be provided such as
simple accessibility of essential machine elements,
possible rapid replacement of essential machine elements or modules,
a simple construction, preferably modular, for simple mass production and storage,
a favorable operation in the event of variable production performance,
a redundancy of essential machine elements with simultaneous possible repair of machine parts during restricted emergency operation,
an improved force flow between the matrix and the drive.

In a pelletizing press, preferably having a circular flat matrix of a larger circumference, only the essential masses of the matrix and the associated support device, which preferably together have a minimum amount of movable mass, advantageously still move. Optimal metering of each roller itself is possible through the stationary, but rotating rollers, in that the material is applied to the matrix directly in front of each roller. The support device of the matrix consists of at least two coaxial support rings and/or a support plate, which preferably support the matrix as flatly as possible. Through the effective support it is possible to use very thin matrices. Segmented matrices are particularly preferably arranged on the support rings or the support plate, which are particularly preferably smaller in their dimensions than the distances between the individual press frames, so that a direct replacement of the matrix segments is possible without greater enlargements of press frames. Fundamentally, the open or multipart press frames can be lifted off of the matrix without problems, the bearings preferably remaining in location below the matrix and still continuing their function during emergency operation or reduced operation.

A further advantage is that via a very direct drive flow of the torques, the matrix can be driven as directly as possible with as few intermediate elements as possible, because due to the movable mounting of the matrix in the press frames and the expansion of the internal diameter which is thus possible, large matrix diameters are now producible and controllable, and therefore space is accordingly present between individual press frames to position a drive having a pinion directly in between them.

The advantageous design and the simple construction of a pelletizing press is described hereafter, at least one pressing device, consisting of at least one roller and/or the matrix inside a press frame, being arranged in the pelletizing press, at least one C-frame and/or at least one window frame being arranged as the press frame. Therefore, individual press frames can be removed from the pelletizing press and during the repair thereof, operation can be continued using the remaining press frames or the pressing devices, respectively. Scattering of the biomass (not described in greater detail) on the matrix is changed accordingly, so that the quantity of biomass located on the matrix still remains in front of every roller in the limits which are permissible for operation. For example, a scattering device can be provided, which supplies the biomass separately to each roller or one press frame, respectively, and which optionally is additionally installed on the press frame and is accordingly also removed or installed in the event of a removal or an installation. In particular, in regard to the arrangement of the actuators (typically hydraulic piston-cylinder arrangements), which is not described in all variations and details, it can be installed in the press frame on a plurality of possible points, which is dependent overall on the construction of the pelletizing press. The matrix is preferably mounted so it is movable in the press frame by means of bearings and the rollers are arranged to be stationary, but movable toward or away from the matrix. It is obvious that the actuators therefore cannot only be used for the adjustment, but rather also can introduce forces for pressing the biomass through the matrix. The bearings of the matrix can preferably also be arranged to be movable in this meaning Preferably, in the case of a large pelletizing press having greater than 750 mm, particularly preferably having greater than 1000 mm internal diameter of the matrix, having more than three, preferably having more than five, particularly preferably having more than seven pan grinder rollers, at least two or more drives are arranged. At least one bearing of the matrix can also be arranged outside a press frame, in order to ensure a sufficient support of the matrix in particular in the case of a small number of press frames. A one-piece or multipart press frame can preferably be arranged as the pressing device. A multipart press frame is particularly preferably formed from at least one crosshead and two tension brackets. The second crosshead can be substituted either independently or by the arrangement of at least one roller or the axle of the roller arranged in the bearings, respectively. In this context, the multipart press frames are preferably connected by rapidly lockable and unlockable connections, particularly preferably bolts, in order to move at least parts of the press frame rapidly and easily out of or into the pelletizing press. For this purpose, at least one engagement surface for the forks of a forklift or for a crane hook is preferably arranged on the press frame of the pressing device. The pressing devices are preferably arranged uniformly along the matrix 4. Accessory parts, such as at least one scattering device, a scattering guide, and/or a side wall can be arranged on at least one pressing device.

Pelletizing presses can now be constructed modularly in an advantageous manner according to the teaching of the invention. Therefore, for example, during a longer production time period, the production capacity can be adapted as needed by variation of the press frames, so that excessive or inadequate capacities of pellets to be delivered can be avoided in a simple manner. It is also possible with appropriate design to offer a pelletizing press which can be retrofitted later without problems to a customer, who first purchases a pelletizing press having five pressing devices, for example, which can be retrofitted later with further pressing devices or press frames, respectively.

In a further advantageous effect of the invention, a plurality of parts can be designed in simplified form with respect to facility and mechanical engineering, mass production and also replacement part storage being implemented in significantly simplified and cost-effective form through the manifold identical parts (press frames, tension brackets, crossheads, roller bearings, drives, support rings, support table). In a modular pelletizing press having multiple pressing devices or press frames, the press frame particularly preferably has means for accommodating a drive, so that upon expansion of the capacity of a pelletizing press, one drive per pressing device or one drive for every two pressing devices, etc., can also be installed or removed.

The rollers and/or the matrix can execute a stroke due to the actuators in the pressing devices or the press frames, respectively. For example, if the rollers have actuators for a stroke, it is very simple in processing technology in the event of a malfunction in a press frame to move the roller into an idle position and keep it there. The production can continue in the meantime, with the scattering device responsible for this roller optionally being stopped or blocked. This is advantageous in particular if a planned maintenance cycle is approaching or a production cycle will be terminated in the near future and the production must already be stopped for these reasons. It is also conceivable in the case of 24/7 operation that the production can continue slightly reduced in a late shift or night shift until the corresponding maintenance or repair crew begins service on the morning of the next day.

However, it is typically problematic that for such a modular pelletizing press, a suitable settable drive system is not provided, which can grow or shrink with the pelletizing press. Individual drives must be replaced every two or three press frames, for example, in order to adapt them to the performance. However, transmission ratios in particular also cannot be adapted arbitrarily to different drives. Multiple drives on a large gear ring require additional control-technology expenditure, however, because, for example, one drive must operate speed-controlled and the further drives must operate torque-controlled. It is also disadvantageous if, on large support rings, matrices, or similar support elements, the attached or introduced teeth for accommodating the torques from the drives receive damage and must be repaired. It is therefore necessary to exchange or replace an entire matrix mount.

An expansion of the object thus comprises refining the above-described pelletizing press having movable matrix so that in conjunction with a modular frame construction, a suitable drive, which is preferably adaptable to the required performance, can be used. In an expansion, it is to be possible to modularly replace the drive by means of suitable replacement segments, so that damage to the drive, in particular to the power providers, can be replaced rapidly and simply. For this purpose, it would be advisable, to generate the movement of the matrix, for the drive to be arranged as a direct drive having a rotor and at least one stator, the rotor being arranged on at least one hollow shaft, a support ring, the support plate, and/or on the matrix itself.

It would therefore now be possible to adjust a drive variably to a varying number of press frames and/or roller arrangements, and the drive can be modularly expanded and/or reduced in size and sudden stoppages or blockades in the production, in particular of a moving matrix table, can be reacted to without damage. Furthermore, the drive is adaptable in its required properties to the production circumstances, whether through partial activation/shutdown or installation/removal of driving components.

It would also be advantageous that large transmissions or conversion mechanisms for the drive having accompanying noise pollution and also maintenance expenditure may be avoided. Through the minimization of the secondary noise, it is also easier to recognize problems during the pressing based on the noise development.

In a preferred application of similar power providers in form, construction, and/or power consumption, the possibility results of improved installation capability, storage, and repair capability. In particular it is possible to offer different performance concepts (power consumption of the motors in kilowatts) in one press production series, which are also changeable easily and without complication later. For example, the power providers can be constructed so that even-numbered multiples of the power providers can be arranged around the periphery of a stator.

If, in an exemplary embodiment, 64 power providers each having 10 kW can be installed in one stator of a direct drive, a press series could be offered which offers a motor power of 640, 320, 160, or 80 kW, for example, so that a customer can order a small pelletizing press at 160 kW and can later equip it for 320 kW or 640 kW without difficulties by purchasing further power providers, for example, in the case of the pressing of less yielding material or retrofitting further press frames. In this context, the repair may also be made easier, because in the event of disturbances or defects in the drive of a pelletizing press, the entire motor no longer has to be replaced, but rather in the case of a defect of a power provider, only this power provider is still removed and replaced by a new power provider. Power providers are understood in the present invention in this context as, for example, a drive coil winding for the permanent magnets fastened on the rotor. In particular, it is advantageous that the motor does not consist of one unit, but rather a plurality of units, which can accordingly be exchanged or successively installed. This is useful in particular in a tight construction space. In the further meaning, however, this also promotes the storage of identical components (power providers) and the repair capabilities. In particular, it is provided that the power providers are preinstalled on prefinished segments, for example, four 45° elements to form a stator, and these four segments are successively installed in the pelletizing press. In a rotor having radially arranged permanent magnets, for example, the hollow shaft (also parts of the hollow shaft) can be placed in the pelletizing press before or after the installation of the power providers, which is correspondingly advantageous for the construction progress of the pelletizing press itself. A parallel installation, for example, two segments or multiple power providers, then the introduction of the hollow shaft and subsequently the final installation of the remaining elements, is also conceivable, of course. The hollow shaft is preferably first coarsely mounted in the pelletizing press, then the remaining power providers are installed, and subsequently the alignment of the shaft or the rotor in relation to the partially or completely installed stator is performed. Subsequently, the stator segments or individual power providers, respectively, are installed. If this has not already occurred during the installation, the hollow shaft or the support structure of the elements to be driven is installed and an alignment of the internal construction of the motor, i.e., the rotor to the stator, is performed.

Advantages of a Direct Drive:

Through the close construction of a direct motor, preferably in direct proximity to a matrix or the support structure to be moved, varying load in the drivetrain can be relayed on the output side in a manner harmless to the system, the overall stiffness of the drivetrain being able to be significantly increased and/or the overall length of the drivetrain being able to be minimized simultaneously. The required installation space of the pelletizing press having a direct drive can be substantially optimized and reduced in size, and simple measures may be implemented for noise damping of essentially the drivetrain by encapsulation. The pelletizing press can be implemented having a low overall height, which results in advantages in particular in the supply of the pelletizing press with biomass and the removal of the pellets.

Furthermore, in the advantageous arrangement of the direct drive, in particular within the required and stiffening support structures of the pelletizing press, a significantly stiffer drive system results and, accompanying this, a reduction of the shaft torsion or of the drivetrain, respectively. If the hollow shaft is driven as the main drive shaft by motors located far away, the torsion of the hollow shaft has a disadvantageous effect on the overall drive system. The longer the distance between the motor and the matrix plane or the roller plane, respectively, the softer the drive system, and control oscillations occur, because the driven hollow shaft acts like a torsion spring.

An improved control-technology quality of the overall system of the pelletizing press also results. Through the high stiffness of the drive system and the precisely settable torque and angular position regulation of the drive, processing data can be detected directly from the peripheral velocity and therefore the throughput per hour. The press does not have any additional mechanical transmission elements (e.g., transmission stages) due to the direct drive and less oscillation and noise results. Friction losses, torsion, tooth flank play, etc., are eliminated. Permanent magnet motors, in particular in the case of a high drive power, still have a quite high noise level, however. However, the noise emissions can be simply reduced by the improvements with respect to a compact construction, which can be more easily encapsulated, and the overall efficiency of the press is also significantly improved, because substantially less unused force occurs due to the torsion or the torque absorption in the bearings in the case of an overhung mounting of the motor. Furthermore, such an embodiment can be encapsulated more easily in order to dampen noises. The preferred arrangement of the direct drive would be provided between the matrix plane and at least one further substantially parallel spaced-apart delimitation plane, the distance between the matrix plane and the delimitation plane being +/−500 mm along the matrix axis. In an alternative dimensioning rule, the force introduction areas would be arranged essentially in a transmission area, the suitable transmission area being located between the matrix plane and at least one further delimitation plane, the delimitation planes being arranged at a delimitation angle of 0 to 30° in relation to the matrix plane and having a common intersection point S on the matrix axis with the matrix plane. A delimitation angle of 0 to 25°, in particular 0 to 20°, is particularly preferred.

As already mentioned, the matrix and/or at least one roller can be movable in at least one press frame by means of the drive in the pelletizing press. The stator is preferably at least partially operationally linked to a press frame. The direct drive is preferably a permanent magnet motor having permanent magnets arranged on the rotor. Other direct drives having direct shaft drive, and also other or newer direct drives can also be provided, the hollow shaft or an equivalent support structure for the drive/mounting of at least two rollers and/or the matrix preferably being considered to be the shaft here. The stator of the drive is preferably implemented in a segmented embodiment, at least two power providers which can be separately electronically activated being arranged in combination. In the case of multiple power providers, they may be installed individually or in groups. In a segmented stator, at least one power provider can also be arranged on at least one press frame. Furthermore, it is preferable for the rotor of the drive to be implemented in one piece with the matrix and/or the support plate and/or the support structure of the roller connection or the matrix. The direct drive is preferably arranged in its plane, in particular in the central (geometric center) plane, perpendicularly to the matrix axis, the plane being led at least through one roller, through an axis of the rollers, through the matrix, a support structure to be assigned thereto, and/or through a hollow shaft. It is therefore simultaneously ensured that unnecessary torsion torques are avoided on an extended support structure or a hollow shaft, in order to avoid torsion tensions. At least the stator of the drive is to consist of at least two power providers, the power providers are to be implemented as independent and replaceable units, and the power providers are to be operationally linked individually or sectionally to a control unit by means of supply lines.

With respect to the many possibilities, methods, in particular for operating a pelletizing press, may also be recognized from the mentioned possibilities.

Further advantageous measures and embodiments of the object of the invention are disclosed in the subclaims and the following description with the drawing.

In the figures:

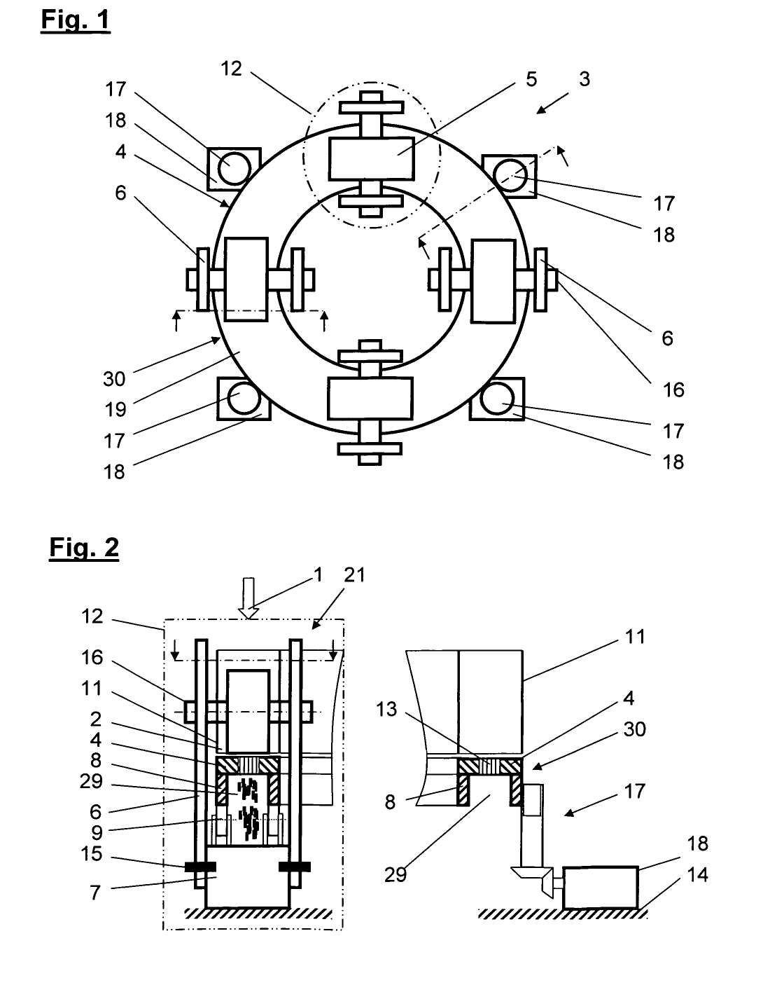

FIG. 1 shows a top view of a circular flat matrix and multiple rollers rolling thereon in four pressing devices or press frames, respectively, the flat matrix being mounted so it is movable in the press frames and rotating around its axis in this preferred embodiment,

FIG. 2 shows two lateral sectional views corresponding to the section lines according to FIG. 1 through a press frame (left) and a drive (right) on a matrix,

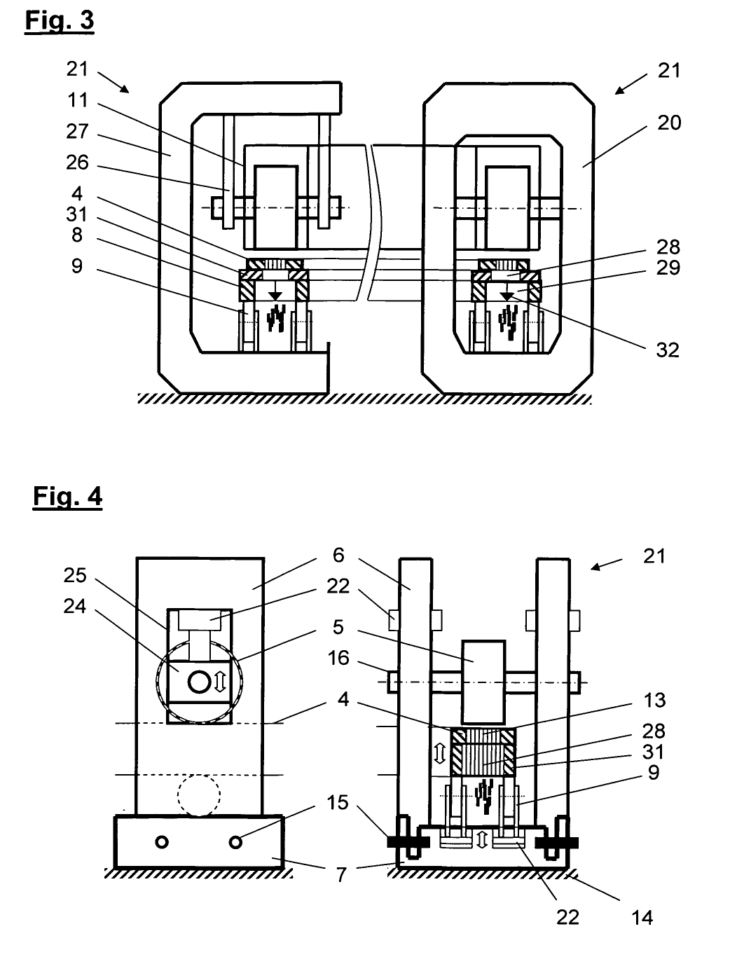

FIG. 3 shows a comparison of two different press frames having a C-frame (left) and a one-piece window frame (right),

FIG. 4 shows two side views of a multipart press frame or a constructed press frame, respectively, having emphasized illustration of possible actuators for adjusting the location of the matrix and/or the rollers to one another,

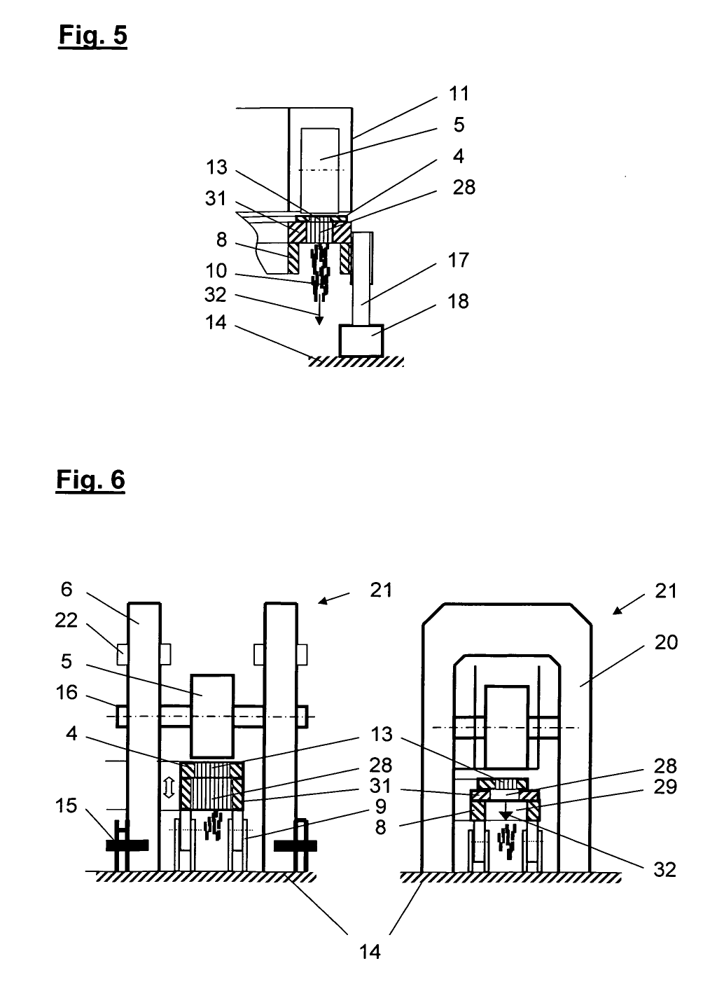

FIG. 5 shows a multipart construction of a movable support device for a matrix consisting of a support table and two coaxial support rings having an exemplary drive,

FIG. 6 shows an exemplary embodiment of a foundation-based pelletizing press,

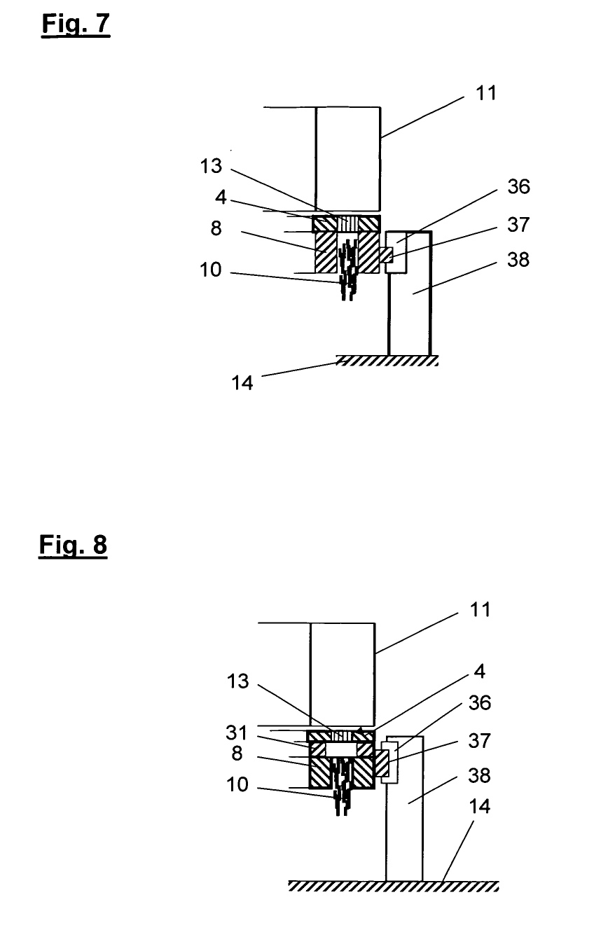

FIG. 7 shows a possible embodiment of the implementation of the rotor or the arrangement of a stator on an independent stator carrier, respectively,

FIG. 8 shows a further variation of the drive having an expanded composite of the rotor not only with the support structure (support rings), but rather having a support plate which supports the matrix for the most direct possible drive force transmission to the matrix, without the replaceable matrix being part of the rotor,

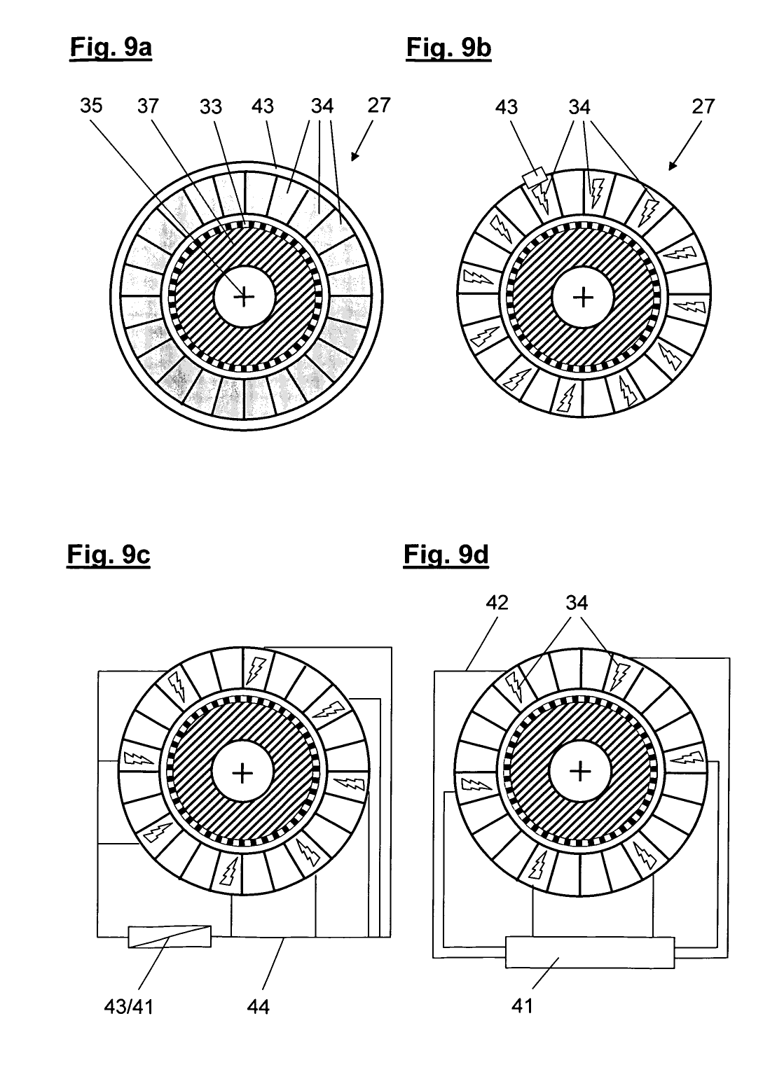

FIG. 9 shows four schematic sectional views of a direct drive consisting of a stator and a rotor on a hollow shaft having different numbers of the power providers,

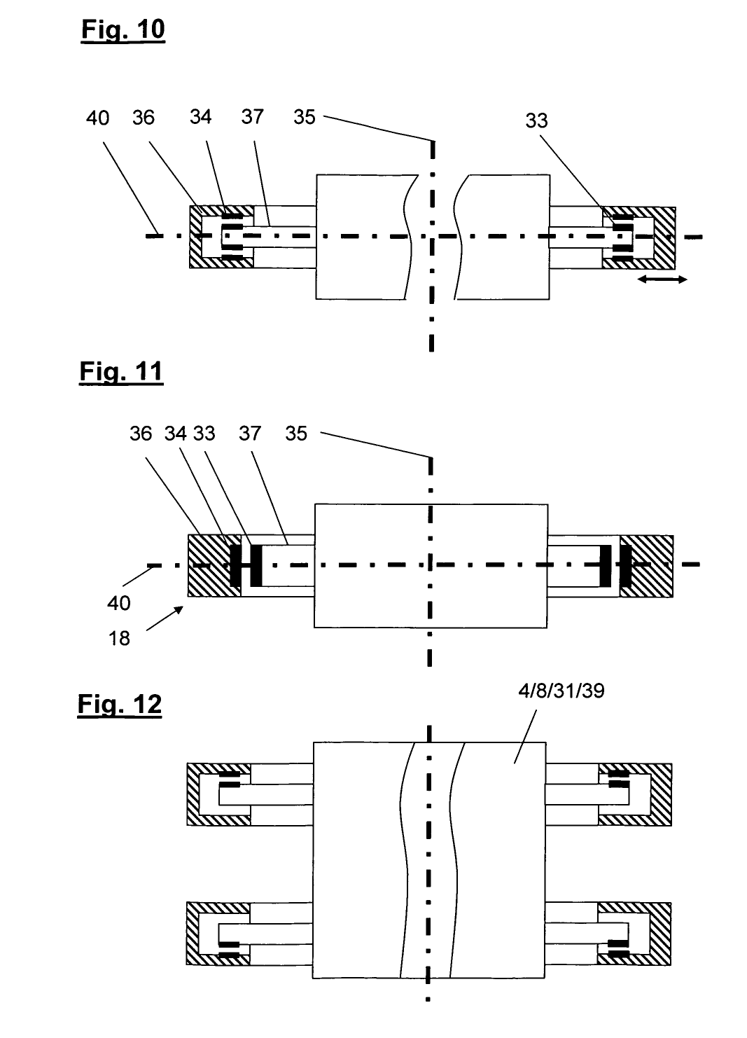

FIG. 10 shows a possible illustration of a direct drive having a power provider which envelops the permanent magnets on a rotor,

FIG. 11 shows a further possible alternative of a direct drive having radial external permanent magnets for the simplified removal and installation,

FIG. 12 shows a particularly preferred arrangement of two direct drives for mutual magnetic force compensation.

A pelletizing press 3 having four pressing devices 12 is shown in FIG. 1 in a preferred exemplary embodiment. However, partially as a function of the internal or external diameter of the matrix, a plurality of pressing devices 12 can also be arranged in the pelletizing press 3. A pressing device 12 consists at least of a press frame 21 in a one-piece or multipart embodiment and a roller 5 mounted so it is movable therein, the roller 5 executing its movement in the direction of or opposite to the rolling surface 19. The matrix 4 is mounted so it is movable in the pressing devices 12 and passes through them to compress the biomass 1 in the boreholes 13 by means of the rollers 5. The matrix 5 or the support device of the matrix 5 is driven via means for torque transmission and by at least one drive 18. A transmission 17 is preferably arranged between the drive 18 and the matrix 4. In the case of a flat, circular matrix, a circular movement around the axis of the matrix 4 thus results, the rollers 5 alternately passing through the pressing devices 12 or the press frames 21, respectively. An exemplary transmission 17 consists of a drive pinion of the drive 18 and teeth 30, which are arranged externally on the matrix 4 or the support device, which consists of at least two coaxially arranged support rings 8 and/or a support plate 31. The teeth can also be arranged on the internal diameter of these elements.

FIG. 2 shows the foundation 14 of the pelletizing press 3, in the schematic sectional view, a press frame 21 having a multipart press frame, which consists of at least one lower crosshead 7 and two tension brackets 6, being arranged on the left, the axle 16 of the roller 5, which is mounted in the tension brackets 6, being held so it is movable with the aid of corresponding machine elements, respectively bearings 24 and actuators 22 (FIG. 4). During the rolling on the rolling surface 19 of the matrix 4, the biomass 1 is compressed through the boreholes 13 to form pellets 10. The introduction of the biomass 1 between the side walls 11 of the pelletizing press 3 is only schematically shown. Biomass 1 is preferably applied directly in front of or onto each roller by means of a conveyor device. The driven matrix 4 in this example is supported by means of bearings 9 on the lower crosshead 7 and therefore effectively and uniformly terminates the present load flow within the pressing device 12, or the press frame 21 or the press frames 20, 27. In addition to the intrinsic weight of the rollers 5, actuators 22 can also be arranged, which, in addition to a possibly required spacing setting between roller 5 and matrix 4, can also ensure an optionally reinforced force introduction onto the material to be compressed, or the biomass 1, respectively. In a possible variant of a constructed press frame 21, the pressing device 12 can have a separate upper crosshead (not shown). In a preferred exemplary embodiment, multipart press frames 21 have locks or bolts 15, using which they can be disassembled rapidly. It is helpful if parts of the press frame 21 have engagement surfaces, using which a lifting device, for example, a crane hook (not shown) and/or at least one forklift fork, can be operationally linked to a part of the press frame 21 and can easily remove at least this part from the pelletizing press 3 or also introduce it. For example, if the bolts 15 on the lower crosshead 7 of the press frame 7 are disengaged, the two tension brackets 6 can be withdrawn upward with the roller 5 and its axle 16 without problems from the pelletizing press 3. This method is particularly advantageous because the lower crosshead 7 can still remain on the foundation 14 and the bearings 9 can continue to support the matrix 4 during a resumed operation of the pelletizing press 3. This variant is particularly preferred having an additional upper crosshead or an upper crosshead which can be plugged on or provided in the case of the introduction or removal of a segment of the multipart press frame 21. It is to be noted that if a multipart ring-shaped matrix is used, it can be disassembled and a closed window frame 20 can also be removed from the pelletizing press, if necessary. The matrix 4 shown here is arranged on a support device, which is constructed from two coaxial support rings 8 and between which a ring chamber 29 is implemented. Baffles or guide means for the pellets 10 were not shown further, in order to ensure the clarity of the schematic illustration. The teeth 30 are preferably only arranged externally on the outer, larger support ring 8.

FIG. 3 shows a comparison of two different press frames 21 having a C-frame 27 and a one-piece window frame 20. It is also shown to the contrary that the roller 5, or the axle 16, is mounted in separate support arms 26 on the left side of the figure, while in contrast on the right side of the figure, the roller 5 is arranged in the vertical branches of the closed window frame 20. These two alternatives would obviously be exchangeable and are also conceivable in still other variants depending on the embodiment of the pelletizing press 3. Furthermore, it can be seen that a support plate 31 is arranged between the support rings 8 and the matrix 4. Multiple boreholes 13 of the matrix 4 are preferably arranged on at least one opening 28 in the support plate 31 and/or essentially the same number of openings 28 is arranged in the support plate 31 as boreholes 13 in the matrix 4, the openings 28 being implemented substantially larger than the boreholes 13. This is used above all to differentiate that the support plate 31 has no decisive component in the embodiment of the pellets 10 and is rather only responsible for feeding through the pellets to a solidly supported matrix 4. Particularly preferably, at least one of the support rings 8 and/or the support plate 31 is implemented substantially larger in its axial extension than in a radial extension.

FIG. 4 shows two side views of a multipart press frame 21 of a pressing device 12 having emphasized illustration of possible actuators 22 for adjusting the location of the matrix 4 and/or the rollers 5 to one another. To adjust the roller 5 in or on the press framework 21 in at least one tension bracket 6, a window 25 or an equivalent opening or a protrusion thereon is attached, on which at least one actuator 22 and/or a bearing 24 is arranged, so that the roller 5 is movable as shown by a double arrow in the vertical direction away from the matrix 4 or toward the matrix 4. The bearings 9 of the matrix 4 can also be arranged as adjustable by means of a actuator 22. In particular using a hydraulic cylinder-piston arrangement as the actuator 22, forces can be caused in the pressing device 12 to promote the compression of the biomass 1. The actuator can advantageously also act as a vibration damper of the pelletizing press 3.

It is particularly advantageous in a vertically-adjustable matrix 4 that the removal of a bearing 9 from the press frame 21 is simplified if the actuators 22 extend further press frames 21 and raise the matrix 4. Alternatively, of course, the matrix 4 can also be raised by means of external aids or the tension brackets 6 are first raised after removing the bolts 15 and subsequently the bearings 9 are changed. In particular, the possibility exists of performing work within the matrix ring in the case of circular matrices 5. Moreover, it can be advisable to provide the motors 18 for driving the matrix 4 directly in the press frames 21. The required drive power, which is typically dependent on the number of the rollers 5, can therefore be adapted directly to the number of the pressing devices 12. In the present drawing, the matrix 4 is only mounted on the support plate 31, the opposing openings 28 for each borehole 13 being shown clearly here.

Moreover, a pressing device 12 can also be constructed from multiple press frames, if the design of the pelletizing press 3 requires it. For example, a press frame can consist of multiple C-frames and/or window frames 27, 20 or multipart window frames 6, 7 arranged parallel to one another. The press frames 21 are preferably operationally linked (not shown) by means of a connection in the area of the foundation 14 and/or essentially in the area of the rollers 5. It is also conceivable that roller bearings are arranged as the bearings 9 on the press frame 21 or on the support rings 8 or on the support plate 31, a rolling surface for the bearings which connects the press frames being arranged if the roller bearings are arranged on the support rings 8 or on the support plate 31.

FIG. 5 once again shows a multipart construction of a movable support device for a matrix 4 comprising a support plate 31 and two coaxial support rings 8 having an exemplary overlapping drive 18 or an overlapping transmission 17. Depending on the torques to be applied, it can be necessary to implement the teeth 30 as long as possible.

FIG. 6 shows an exemplary application of a foundation-based pelletizing press. A C-frame or U-frame open on one side is arranged on the right in such a manner that the open side is arranged in the direction of the foundation 14 and the matrix 4 is guided through the opening thus resulting. The bearings 9 can be arranged directly on the foundation 14, or a corresponding guide is arranged on the foundation, if the bearings 9 are arranged on the table device, or the support ring 8 and/or the support plate 31, respectively. A multipart press frame is shown on the left side, which is fixed by means of bolts 15 on a fastening means arranged on the foundation 14. Both press frames can be lifted off of the foundation, preferably after opening a quick-release device. In both variants, the foundation substitutes for the required lower crosshead.

With respect to the dimensioning, it has been shown that the effective width of the rollers 5 is to be between 200 and 500 mm, preferably essentially 300 mm. The diameter of the matrix 4 is to be between 1.5 and 5 m, are firmly between 2.5 and 3 m, in particular 2.85 m. A pan grinder diameter of 300 to 500 mm is advantageous, a diameter of essentially 400 mm is particularly preferred.

FIG. 7 shows an indirect drive of the matrix 4, which is mounted on at least one, preferably two concentrically mounted support rings 8. At least one of the support rings 8 implements a part of the rotor 37 and is driven by means of the stator 36 of the drive 18, the stator 36 being mounted stationary on a stator support 38 which is operationally linked to the foundation.

FIG. 8 shows an alternative embodiment in which the matrix 4 is arranged on a support plate 31, which is in turn operationally linked to the support rings 8. The rotor 37 is directly operationally linked to the support plate 31 and/or to the support rings 8. For both figures, this can also be implemented on the “inner” support ring 8 or a hollow shaft can be arranged internally or externally, on which the drive 18 drives, the hollow shaft finally in turn driving the support structure or the matrix itself.

FIG. 9 shows four schematic sectional views of a drive 18 implemented as a direct drive, consisting of a stator 36 made of multiple power providers 34 and a rotor 37, operationally linked to a matrix, a structure (support plate) or the like holding the matrix 4. The stator 36 of the motor 18 consists of twenty-eight (FIG. 9a), twelve (FIG. 9b), eight (FIG. 9c), or alternately six (FIG. 9d) power providers 34, which are implemented as independent and exchangeable units. The power providers 34 are arranged radially to the matrix axis 35 and the power providers 34 are operationally linked individually or sectionally to a control unit 41 by means of supply lines 42. The areas which are not marked by a lightning sign and are therefore free for optional power providers 34 are depicted for clarity and for better illustration of the power providers 34, which are exchangeable with one another. Of course, it is also conceivable that three power providers 34 are always arranged adjacent one another while leaving open one free area. In particular, it is advantageous if, in the case of multiple power providers 34, at least two power providers 34 having an equivalent performance and/or an equivalent external shaping are arranged. Shaping is understood as the external dimensions or the arrangement of significant installation elements. The power providers 34 are preferably arranged in groups of at least two. The possibility of connecting the power providers 34 directly or indirectly via a suitable mount to the press frame 21 of a pressing device 12 or a stator carrier 38 is not shown. FIGS. 9b and 9c show the possibility that at least one cooling device 34 is arranged either centrally on the stator 36 or on at least one power provider 34.

The individual supply lines and their exemplary pathway to a control unit 41, which preferably consists of at least one frequency converter, are shown in FIGS. 9c and 9d. In FIG. 9c, the supply lines 42 are combined into supply segments 44 and are alternately supplied directly or to a combined station of control unit 41 and cooling device 43. This is advisable in particular if the control unit 41 also requires continuous cooling. It is not shown that at least parts of the stator 36 and/or supply lines 42 can implement an installation unit.

FIGS. 10 and 11 show a typical and particularly preferred embodiment of the direct drive as the drive 18. In FIG. 10, a drive 18 is arranged as a direct drive on a hollow shaft. A stator 36, which has multiple drive units or power providers 34, respectively, is arranged directly opposite, coaxially to the hollow shaft or to the matrix axis 35, respectively. According to FIG. 11, the power providers 34 are implemented as U-shaped, the stator 36 having the permanent magnets arranged thereon engaging in the opening of the U-shaped power provider 34. The permanent magnets 33 are particularly preferably arranged on both sides respectively on the axial external front sides of the rotor 36. The power providers 34, in their property for providing a drive torque in relation to the permanent magnets, preferably have drive windings or coils, through which current flows.

With respect to a method (not shown in greater detail in the figures) for producing a pelletizing press 3, at least the rotor 37 is moved into the at least partially installed pelletizing press 3 and held temporarily essentially in the area of the drive 18 or arranged ready for operation, subsequently the stator 36 being produced by installing individual power providers 34 or by installing a prefinished installation group made of at least two power providers 34 in the area of the drive. The power providers 34 are particularly preferably connected individually or sectionally to a control unit 41 by means of supply lines 42.

The power providers 34 essentially correspond to a motor coil, using which the permanent magnets 33 can be driven. The more motor coils are arranged, the more power can be generated on the rotor 37 and the drive power increases accordingly. The permanent magnets and/or the power providers/motor coils are preferably arranged in the pelletizing press 3 in such a manner that a magnetic force compensation (FIGS. 10 and 11) results. Of course, this magnetic force compensation cannot always be implemented, for example, if the installation space for the drive is restricted or is location-dependent in the scope of the design and layout of the machine elements. Problems can also result in the installation of a large direct drive, in particular having problematic installation space conditions, which require or only allow a special type of the drive itself.

According to FIG. 12, at least two drives 18, which are preferably activatable separately from one another, are provided as a direct embodiment along the matrix axis, in the case of a one-sided spoke arrangement (FIG. 10 is a two-sided spoke arrangement for the permanent magnets), as shown in this figure, the permanent magnets only being arranged on one flat side of the rotor. Therefore, uncompensated magnetic forces result, which act on the hollow shaft or the rotor along the matrix axis, because the matrix axis is perpendicular to the matrix surface and corresponds to the rotational axis of the matrix. This illustration is very schematic and the reference numerals indicated on a machine elements are to represent the possibility of attaching the rotor to a hollow shaft 39 and/or a support ring 8 and/or a support plate 31 and/or the matrix 4. With respect to the method, it may be stated that a partial or a segmented stator, respectively, may correspondingly be slipped over such a rotor. However, the stator does not have to be implemented in the U-shape shown, but rather also typical geometric shapes are conceivable if adapted to the properties of the drive and the installation space (1391/1410).

### LIST OF REFERENCE NUMERALS 1391/1410

1 biomass

2 compaction chamber

3 pelletizing press

4 matrix

5 roller

6 tension bracket

7 lower crosshead

8 support ring

9 bearing

10 pellets

11 side wall

12 pressing device

13 boreholes

14 foundation

15 bolts

16 axle roller 5

17 transmission

18 drive

19 rolling surface

20 window frame

21 press frame

22 actuator

23 guide means

24 bearing axle 16

25 window

26 support arms

27 C-frame

28 openings

29 ring chamber

30 teeth

31 support plate

32 pressing direction

33 permanent magnet

34 power provider

35 matrix axis

36 stator

37 rotor

38 stator carrier

39 hollow shaft

40 plane of the drive 18

41 control unit

42 supply line

43 cooling device

44 supply segment

1. A pelletizing press for producing pellets from material to be compressed, preferably from biomass for use as fuel in furnaces, the biomass comprising fibers, chips, or shreds containing cellulose and/or lignocellulose, the biomass being compressed in the pressing direction in the pelletizing press by means of at least one rolling roller through the boreholes of a matrix, which is movable by means of at least one drive, and/or rollers to form pellets,
wherein the matrix and/or the rollers are arranged as mounted to be movable in at least two press frames, and the matrix is operationally linked to two coaxially arranged support rings to implement a ring chamber and/or a support plate having openings for feeding through the pellets in the pressing direction.

2. The pelletizing press according to claim 1, wherein means for absorbing a torque from at least one drive are arranged on at least one support ring, the support plate, and/or on the matrix, teeth preferably being arranged as the means for absorbing a torque.

3. The pelletizing press according to claim 1, wherein multiple boreholes of the matrix are arranged on one opening in the support plate and/or essentially the same number of openings are arranged in the support plate as boreholes in the matrix, the openings being implemented substantially larger than the boreholes.

4. The pelletizing press according to claim 1, wherein the rollers and/or the matrix are arranged to be movable in their location to one another in the press frame by means of actuators.

5. The pelletizing press according to claim 1, wherein at least one one-piece or multipart press frame is arranged, a one-piece press frame preferably being implemented as a C-frame or as a window frame, and a multipart press frame being implemented at least from one crosshead and two tension brackets.

6. The pelletizing press according to claim 1, wherein the press frames are operationally linked by means of a connection in the area of a foundation and/or essentially in an area of the rollers.

7. The pelletizing press according to claim 1, wherein at least one of the support rings and/or the support plate is implemented as substantially larger in its axial extension than in a radial extension.

8. The pelletizing press according to claim 1, wherein roller bearings are arranged on the press frame or on the support rings or on the support plate as the bearings, if the roller bearings are arranged on the support rings or on the support plate, a rolling surface which connects the press frames being arranged for the bearings.

9. The pelletizing press according to claim 5, wherein in the case of a press frame which is open on one side or is in multiple parts, the opening of the press frame is assigned to a foundation, or the foundation substitutes for a lower crosshead, the press frame which is open on one side or the tension brackets being arranged directly on the foundation.

10. The pelletizing press according to claim 1, wherein at least one bearing for the matrix is arranged outside the press frame.

11. The pelletizing press according to claim 1, wherein, to generate the movement of the matrix, at least one drive is arranged as a direct drive having a rotor and at least one stator, the rotor being arranged on at least one hollow shaft, a support ring, the support plate, and/or on the matrix.

12. The pelletizing press according to claim 11, wherein the stator is operationally linked to at least one press frame.

13. The pelletizing press according to claim 1, wherein a permanent magnet motor is arranged as the direct drive and permanent magnets are arranged on the rotor.

14. The pelletizing press according to claim 11, wherein the stator of the drive is arranged in a segmented embodiment.

15. The pelletizing press according to claim 14, wherein in the case of a segmented stator, at least two electronically separately activatable power providers are arranged.

16. The pelletizing press according to claim 14, wherein, in a segmented stator, at least one power provider is arranged on at least one press frame.

17. The pelletizing press according to claim 11, wherein the rotor of the drive is implemented in one piece with the matrix and/or with the support plate of the matrix and/or at least one support ring of the matrix.

18. The pelletizing press according to claim 11, wherein at least the stator of the drive comprises at least two power providers, the power providers are implemented as independent and exchangeable units, and the power providers are individually or sectionally operationally linked to a control unit by means of supply lines.

19. The pelletizing press according to claim 15, wherein in the case of multiple power providers, at least two power providers having an equivalent power and/or an equivalent external shaping are arranged.

20. The pelletizing press according to claim 19, wherein the power providers are arranged in groups of at least two.
